(19) United States
(12) Patent Application Publication
(10) Pub. No.: US 2026/0331750 A1
(43) Pub. Date: Oct. 22, 2026

(54) ELECTRONIC DEVICE AND ANTENNA STRUCTURE THEREOF

(71) Applicant: WNC Corporation, HSINCHU (TW)

(72) Inventor: Yen-ming Hong, HSINCHU (TW)

(21) Appl. No.: 19/576,080

(22) Filed: Mar. 24, 2026

(30) Foreign Application Priority Data
Apr. 21, 2025 (TW) 114114890

(51) Int. Cl. H01Q 1/22; H01Q 1/02; H01Q 1/42; H01Q 5/20; H01Q 5/30

(52) U.S. Cl. CPC H01Q 1/22; H01Q 1/02; H01Q 1/42; H01Q 5/20; H01Q 5/30

(57) ABSTRACT

An electronic device includes a metal housing and an antenna structure. The antenna structure is disposed in the metal housing. The metal housing includes a first housing portion and a second housing portion. The antenna structure includes a heat dissipation bracket, a radiating element, and a grounding metal element. The radiating element and the grounding metal element are disposed on the heat dissipation bracket. The heat dissipation bracket has a plurality of through holes. One of the first housing portion and the second housing portion is spaced apart from an upper edge of the radiating element by a first distance, and the other of the first housing portion and the second housing portion is spaced apart from the upper edge of the radiating element by a second distance. A ratio of the first distance to the second distance is 2.1:1.

### CROSS-REFERENCE TO RELATED PATENT APPLICATION

This application claims the benefit of priority to Taiwan Patent Application No. 114114890, filed on Apr. 21, 2025. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to an electronic device and an antenna structure, particularly to an electronic device having a metal housing and a miniaturized multi-band antenna structure disposed inside the metal housing.

### BACKGROUND OF THE DISCLOSURE

Existing electronic devices, such as notebook computers, in pursuit of a thin, light, and aesthetically pleasing appearance, have their housings made of metal materials. A metal housing affects the antenna module inside the electronic product, reducing the communication quality of the electronic product. To avoid affecting antenna characteristics, slots need to be opened in the metal housing to form a radiation clearance area. However, in this way, the product is easily constrained by the slot design and deviates from its requirements for appearance and structural strength.

Therefore, how to overcome the above defects through improvements in structural design has become one of the important issues to be solved in the field.

### SUMMARY OF THE DISCLOSURE

The present disclosure mainly provides an electronic device and an antenna structure to meet the aesthetic appearance requirements of the electronic device without affecting the antenna characteristics inside the electronic device.

To solve the above technical problems, one technical solution adopted by the present disclosure is to provide an electronic device, which includes a metal housing and an antenna structure. The metal housing includes a first housing portion and a second housing portion. The antenna structure is disposed between the first housing portion and the second housing portion. The antenna structure includes a heat dissipation bracket, a radiating element, and a grounding metal element. The heat dissipation bracket has a first surface and a second surface disposed opposite each other, and a third surface and a fourth surface disposed opposite each other. The third surface and the fourth surface are connected between the first surface and the second surface. The heat dissipation bracket has a plurality of through holes penetrating both the first and second surfaces. The radiating element is disposed on the first surface. The radiating element includes a radiating portion, a grounding portion, and a feeding portion. The grounding portion and the feeding portion are connected to the radiating portion. The grounding metal element is disposed on the second surface, the third surface, and the fourth surface. The grounding portion is connected to the grounding metal element. The portion of the grounding metal element located on the third surface is electrically connected to the first housing portion, and the portion of the grounding metal element located on the fourth surface is electrically connected to the second housing portion. One of the first housing portion and the second housing portion is at a first distance from the upper edge of the radiating portion, and the other of the first housing portion and the second housing portion is at a second distance from the upper edge of the radiating portion. The ratio of the first distance to the second distance is 2.1:1.

To solve the above technical problems, another technical solution adopted by the present disclosure is to provide an antenna structure disposed in a metal housing. The metal housing includes a first housing portion and a second housing portion. The antenna structure includes a heat dissipation bracket, a radiating element, and a grounding metal element. The heat dissipation bracket has a first surface and a second surface disposed opposite each other, and a third surface and a fourth surface disposed opposite each other. The third surface and the fourth surface are connected between the first surface and the second surface. The heat dissipation bracket has a plurality of through holes penetrating both the first and second surfaces. The radiating element is disposed on the first surface. The radiating element includes a radiating portion, a grounding portion, and a feeding portion. The grounding portion and the feeding portion are connected to the radiating portion. The grounding metal element is disposed on the second surface, the third surface, and the fourth surface. The grounding portion is connected to the grounding metal element. The portion of the grounding metal element located on the third surface is electrically connected to the first housing portion, and the portion of the grounding metal element located on the fourth surface is electrically connected to the second housing portion. One of the first housing portion and the second housing portion is at a first distance from the upper edge of the radiating portion, and the other of the first housing portion and the second housing portion is at a second distance from the upper edge of the radiating portion. The ratio of the first distance to the second distance is 2.1:1.

One beneficial effect of the present disclosure is that the electronic device and antenna structure provided by the present disclosure, through the structural design of “one of the first housing portion and the second housing portion being spaced apart from an upper edge of the radiating portion by a first distance, the other of the first housing portion and the second housing portion being spaced apart from the upper edge of the radiating portion by a second distance, and the ratio of the first distance to the second distance being 2.1:1,” the ratio of the total height of the radiating element of the antenna structure to the distance between one of the housing portions (the first housing portion or the second housing portion) is maintained at 2.1:1. Thus, the antenna structure of the present disclosure can meet miniaturization requirements while supporting the broadband requirements of Wi-Fi® 6E/Wi-Fi® 7 and maintaining good antenna characteristics.

To further understand the features and technical content of the present disclosure, please refer to the following detailed description and drawings related to the present disclosure. However, the drawings provided are only for reference and illustration and are not intended to limit the present disclosure.

These and other aspects of the present disclosure will become apparent from the following description of the embodiment taken in conjunction with the following drawings and their captions, although variations and modifications therein may be effected without departing from the spirit and scope of the novel concepts of the disclosure.

### BRIEF DESCRIPTION OF THE DRAWINGS

The described embodiments may be better understood by reference to the following description and the accompanying drawings.

FIG. 1 is a schematic diagram of an electronic device according to an embodiment of the present disclosure.

FIG. 2 is a partially enlarged schematic diagram of the electronic device according to an embodiment of the present disclosure.

FIG. 3 is a first schematic diagram of an antenna structure according to an embodiment of the present disclosure.

FIG. 4 is a second schematic diagram of an antenna structure according to an embodiment of the present disclosure.

FIG. 5 is a schematic diagram of a first implementation of a radiating element according to an embodiment of the present disclosure.

FIG. 6 is a schematic diagram of a second implementation of a radiating element according to an embodiment of the present disclosure.

FIG. 7 is a schematic diagram of a third implementation of a radiating element according to an embodiment of the present disclosure.

FIG. 8 is a schematic diagram of a fourth implementation of a radiating element according to an embodiment of the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a”, “an” and “the” includes plural reference, and the meaning of “in” includes “in” and “on.” Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first”, “second” or “third” can be used to describe various components, signals or the like, which are for distinguishing one component/signal from another one only, and are not intended to, nor should be construed to impose any substantive limitations on the components, signals or the like.

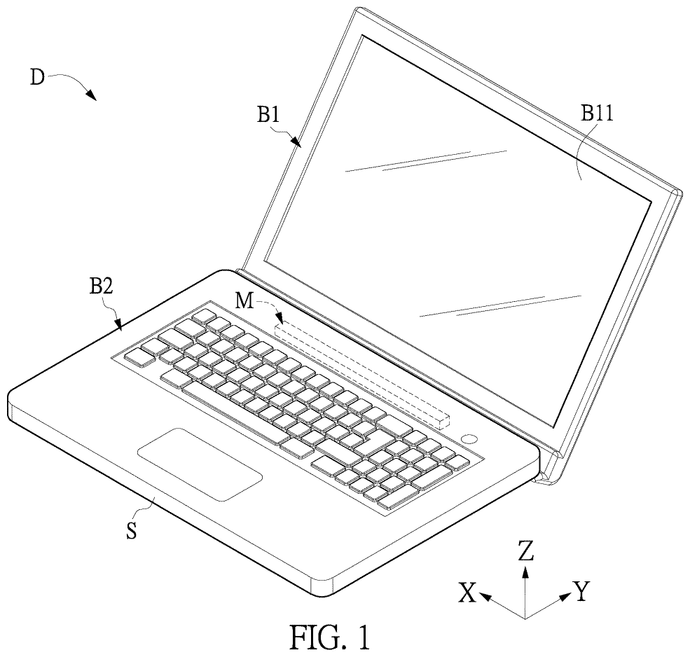

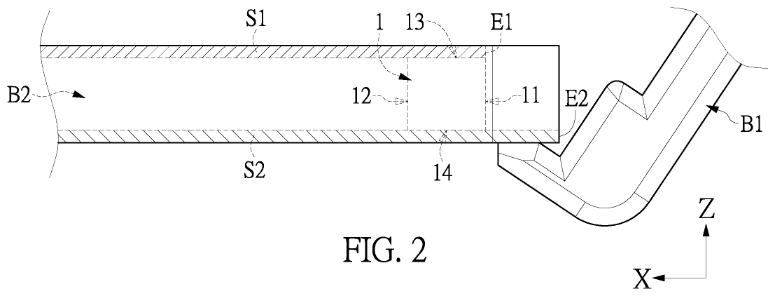

Referring to FIGS. 1 and 2, FIG. 1 is a schematic diagram of an electronic device according to an embodiment of the present disclosure, and FIG. 2 is a partially enlarged schematic diagram of the electronic device according to an embodiment of the present disclosure. The present disclosure provides an electronic device D. The electronic device D may be a smartphone, a tablet computer, or a notebook computer, and the present disclosure is not limited thereto. In the present disclosure, the electronic device D is exemplified as a notebook computer. As shown in FIG. 1, the electronic device D includes a display component B1 and a keyboard component B2. The display component B1 has a display screen B11. The keyboard component B2 of the electronic device D includes a metal housing S and an antenna structure M disposed inside the metal housing S. FIGS. 1 and 2 show the relative position of the antenna structure M inside the electronic device D. The antenna structure M is disposed inside the keyboard component B2 and at a position close to the display component B1. More specifically, the antenna structure M is adjacent to a fan inside the keyboard component B2 (not shown).

As shown in FIG. 2, the metal housing S includes a first housing portion S1 and a second housing portion S2. In this embodiment, the antenna structure M is disposed between the first housing portion S1 and the second housing portion S2. For example, the first housing portion S1 is a metal keyboard cover (commonly referred to as “C parts” in the field of notebook computers) of the keyboard component B2, and the second housing portion S2 is a metal bottom cover (commonly referred to as “D parts” in the field of notebook computers) of the keyboard component B2.

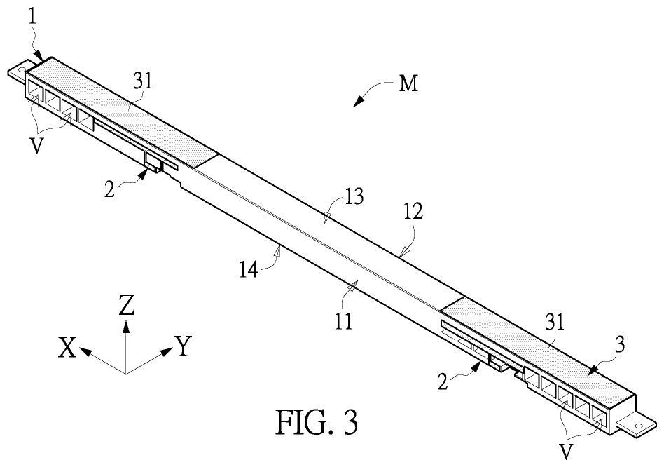

Referring to FIG. 3, which is a first schematic diagram of the antenna structure according to an embodiment of the present disclosure. The antenna structure M includes a heat dissipation bracket 1, a radiating element 2, and a grounding metal element 3. The radiating element 2 and the grounding metal element 3 are disposed on the heat dissipation bracket 1. For example, the heat dissipation bracket 1 may be a support member made of a non-metallic material by 3D printing, and the radiating element 2 and the grounding metal element 3 may be conductors made of a metallic material by laser direct structuring (LDS). In the embodiment of the present disclosure, the basic shape of the heat dissipation bracket 1 is a rectangular cuboid, having first and second surfaces 11, 12 disposed opposite each other, and third and fourth surfaces 13, 14 disposed opposite each other. However, the present disclosure is not limited by the specific shape of the heat dissipation bracket 1. The heat dissipation bracket 1 has a plurality of through holes V, and the plurality of through holes V penetrate the first surface 11 and the second surface 12. The plurality of through holes V can be used as heat dissipation holes, and the metal housing S is provided with vents (not shown) at positions corresponding to the plurality of through holes V. Therefore, airflow generated by a fan inside the keyboard component B2 can transport waste heat generated inside the electronic device D to the external environment through the plurality of through holes V and the vents, thereby achieving a heat dissipation effect. In other words, the antenna structure of the present disclosure is combined with a heat dissipation vent structure of the electronic device D.

The radiating element 2 is disposed on the first surface 11 of the heat dissipation bracket 1. As shown in FIG. 2, the display component B1 of the electronic device D of the present disclosure adopts a sunken hinge structure design. When the electronic device D is in a form being operated by a user, that is, when the user opens the upper cover (the display component B1 of the notebook computer) of the electronic device D, the portion where the display component B1 is connected to the keyboard component B2 is lower than the bottom surface of the keyboard component B2 (i.e., the bottom surface of the second housing portion S2), so the first surface 11 of the heat dissipation bracket 1 and the radiating element 2 disposed on the first surface 11 are both arranged to face the display component B1. In addition, the first surface 11 of the heat dissipation bracket 1 is flush with the front edge E1 of the first housing portion S1, and the front edge E2 of the second housing portion S2 protrudes in the negative X direction beyond the first surface 11 of the heat dissipation bracket 1 (protruding by about 7.9 mm). As shown in FIG. 2, the front edge E2 of the second housing portion S2 is closer to the display component B1 than the front edge E1 of the first housing portion S1.

The antenna structure M of the present disclosure is mainly used as a Wi-Fi® antenna structure to support the broadband requirements of Wi-Fi® 6E/Wi-Fi® 7. As shown in FIG. 3, in the embodiment of the present disclosure, the antenna structure M includes two radiating elements 2, and both radiating elements 2 are disposed on the first surface 11. In the following, the present disclosure will be illustratively described using a single antenna structure M.

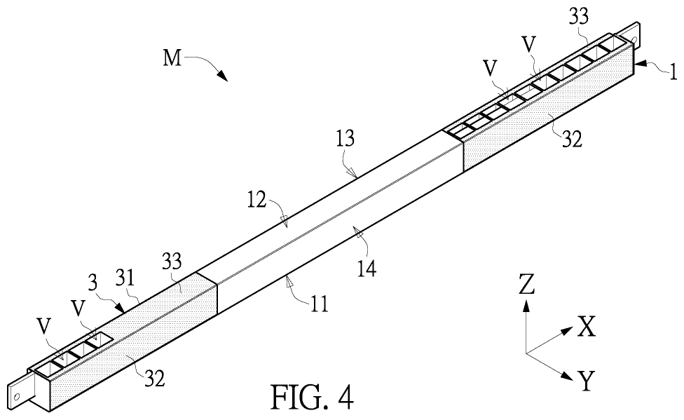

Referring to FIGS. 3 and 4, FIG. 4 is a second schematic diagram of the antenna structure according to an embodiment of the present disclosure. The grounding metal element 3 is disposed on the second surface 12, the third surface 13, and the fourth surface 14. The grounding metal element 3 includes a first grounding metal portion 31, a second grounding metal portion 32, and a third grounding metal portion 33. The first grounding metal portion 31 is disposed on the third surface 13 of the heat dissipation bracket 1, the second grounding metal portion 32 is disposed on the fourth surface 14 of the heat dissipation bracket 1, and the third grounding metal portion 33 is disposed on the second surface 12 of the heat dissipation bracket 1. The third grounding metal portion 33 connects the first grounding metal portion 31 and the second grounding metal portion 32.

Referring to FIGS. 2 to 4, the portion of the grounding metal element 3 located on the third surface 13, i.e., the first grounding metal portion 31, is electrically connected to the first housing portion S1; the portion of the grounding metal element 3 located on the fourth surface 14, i.e., the second grounding metal portion 32, is electrically connected to the second housing portion S2. Therefore, in the present disclosure, at least three surfaces of the heat dissipation bracket 1 are provided with metal conductors (e.g., copper foil), i.e., the first surface of the heat dissipation bracket 1 is provided with the radiating element 2, and the second surface 12, the third surface 13, and the fourth surface 14 of the heat dissipation bracket 1 are covered by the grounding metal element 3. The first grounding metal portion 31, which is disposed on the third surface 13, closely abuts the first housing portion S1, and the second grounding metal portion 32, which is disposed on the fourth surface 14, closely abuts the second housing portion S2.

Referring to FIGS. 2 to 5, FIG. 5 is a schematic diagram of a first implementation of the radiating element according to an embodiment of the present disclosure. The radiating element 2 includes a radiating portion 21, a grounding portion 22, and a feeding portion 23. The grounding portion 22 and the feeding portion 23 are connected to the radiating portion 21. The radiating portion 21, the grounding portion 22, and the feeding portion 23 are substantially in an inverted-F shape. The grounding portion 22 is connected to the grounding metal element 3. The grounding portion 22 may be connected to the first grounding metal portion 31 or the second grounding metal portion 32, and the present disclosure is not limited thereto. In the embodiment of the present disclosure, the grounding portion 22 is connected to the second grounding metal portion 32 located on the fourth surface 14, and is electrically connected to the second housing portion S2 through the second grounding metal portion 32. In other embodiments, the radiating element 2 can be inverted so that the grounding portion 22 can be connected to the first grounding metal portion 31 located on the third surface 13, and can be electrically connected to the first housing portion S1 through the first grounding metal portion 31.

Furthermore, since the second grounding metal portion 32 located on the fourth surface 14 closely abuts the second housing portion S2, the distance between the fourth surface 14 and the upper edge 21T of the radiating portion 21, which is equal to the distance between the second housing portion S2 and the upper edge 21T of the radiating portion 21, is defined as a first distance H1. On the other hand, since the first grounding metal portion 31 located on the third surface 13 contacts the first housing portion S1 (the first grounding metal portion 31 and the first housing portion S1 are not necessarily closely abutted), the distance between the third surface 13 and the upper edge 21T of the radiating portion 21, which is equal to the distance between the first housing portion S1 and the upper edge 21T of the radiating portion 21, is defined as a second distance H2. The first distance H1 is greater than the second distance H2. In some embodiments, the ratio of the first distance H1 to the second distance H2 is 2.1:1.

Since the antenna structure M of the present disclosure is combined with the heat dissipation vent structure of the electronic device D, the antenna structure M is located at a position close to the display component B1. However, the display component B1 of the electronic device D adopts a sunken hinge design: when the user opens the upper cover (the display component B1), the portion where the display component B1 is connected to the keyboard component B2 is lower than the bottom surface of the keyboard component B2, resulting in the radiation surface of the antenna structure M being obstructed, which affects the antenna characteristics. In addition, the front edge E2 of the second housing portion S2 of the metal housing S of the electronic device D protrudes in the negative X direction beyond the first surface 11 of the heat dissipation bracket 1, that is, closer to the display component B1 (see FIG. 2). The design of the second housing portion S2 is intended to reduce the Specific Absorption Rate (SAR) of electromagnetic energy. However, in this way, since the second housing portion S2 protrudes beyond the first surface 11 of the heat dissipation bracket 1 (i.e., the radiating surface of the antenna structure M), it will also affect the antenna characteristics and reduce the antenna performance.

To resolve the above interference, the present disclosure adopts a design in which the ratio of the first distance H1 to the second distance H2 is 2.1:1, that is, the ratio of the total height of the radiating element 2 of the antenna structure to the distance between one of the housing portions (the first housing portion or the second housing portion) is maintained at 2.1:1, and in combination with the grounding extension structure formed by the grounding metal element 3 electrically connecting the first housing portion S1 and the second housing portion S2, the antenna structure M can maintain good antenna characteristics and performance without being affected by the shielding of the radiating surface, and meet the broadband requirements of Wi-Fi® 6E/Wi-Fi® 7.

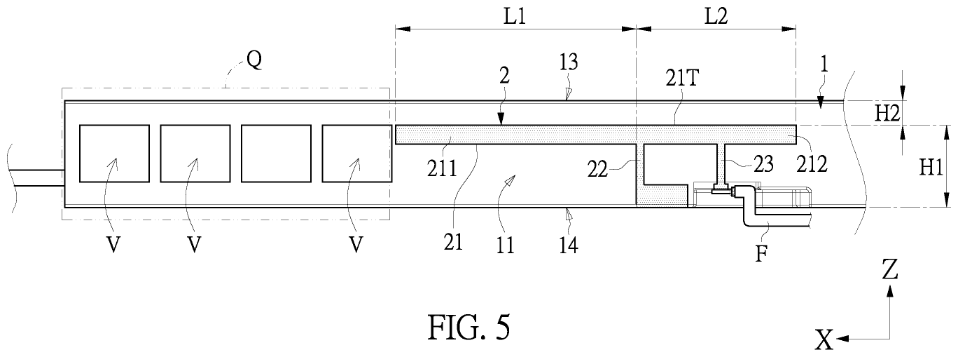

Referring to FIG. 5, the radiating portion 21 includes a first arm 211 and a second arm 212. The feeding portion 23 is connected between the first arm 211 and the second arm 212. The first arm 211 and the second arm 212 extend in opposite directions relative to the feeding portion 23. In addition, the length L1 of the first arm 211 is greater than the length L2 of the second arm 212, and the grounding portion 22 is connected to the first arm 211.

The feeding portion 23 of the radiating element 2 is electrically connected to a feeding element F. It should be noted that the feeding element F can be disposed according to the orientation of the radiating element 2. For example, referring to FIGS. 2 and 5, in this embodiment, the feeding element F is close to the second housing portion S2. However, in an inverted configuration of the radiating element 2, the feeding element F is close to the first housing portion S1. The antenna structure M receives a signal through the feeding element F, so that the feeding portion 23 and the first arm 211 can be excited to generate a first operating frequency band, and the feeding portion 23 and the second arm 212 can be excited to generate a second operating frequency band and a third operating frequency band, and the second operating frequency band and the third operating frequency band are both higher than the first operating frequency band.

In some embodiments of the present disclosure, the range of the first operating frequency band can be from 2400 MHz to 2500 MHz, the range of the second operating frequency band can be from 5150 MHz to 5850 MHz, and the range of the third operating frequency band can be from 5925 MHz to 7125 MHz. In addition, when the feeding element F feeds a signal from the feeding portion 23, the feeding portion 23 forms a loop with the grounding portion 22 and the grounding extension structure (including the grounding metal element 3, the first housing portion S1, and the second housing portion S2) connected to the grounding portion 22. In addition, in the present disclosure, the first distance H1 can be from 0.035 to 0.045 wavelength (0.035λ~0.045λ) of the first operating frequency band. In some embodiments, the first distance H1 can be 0.042 wavelength (0.042λ) of the first operating frequency band.

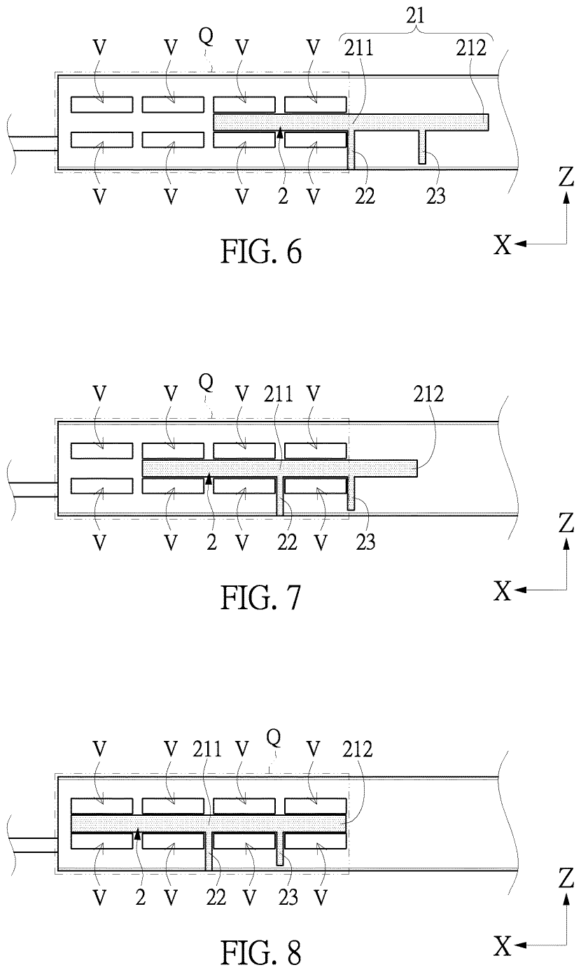

In addition, in FIG. 5, the plurality of through holes V form a heat dissipation vent region Q on the first surface 11, and the radiating element 2 is located outside the heat dissipation vent region Q. However, the present disclosure is not limited regarding the placement position of the radiating element 2 on the first surface of the heat dissipation bracket 1. Referring to FIGS. 6 to 8, FIG. 6 is a schematic diagram of a second implementation of the radiating element according to an embodiment of the present disclosure, FIG. 7 is a schematic diagram of a third implementation of the radiating element according to an embodiment of the present disclosure, and FIG. 8 is a schematic diagram of a fourth implementation of the radiating element according to an embodiment of the present disclosure. For example, as shown in FIG. 6, a portion of the radiating element 2, specifically the first arm 211, extends into the region where the plurality of through holes V are located, i.e., inside the heat dissipation vent region Q. Furthermore, as shown in FIG. 6, the plurality of through holes V are divided into two rows, the two rows of through holes V are arranged side-by-side, and each row of through holes V is parallel to the extending direction of the radiating portion 21. At least a portion (the first arm 211) of the radiating portion 21 is located between the two rows of through holes V.

In some embodiments, for example, as shown in FIG. 7, the radiating element 2 further extends into the heat dissipation vent region Q (compared to FIG. 6), and the first arm 211 of the radiating portion 21 and the grounding portion 22 may be located within the range of the heat dissipation vent region Q. For example, in some embodiments, as shown in FIG. 8, the radiating element 2 may be located entirely within the range of the heat dissipation vent region Q. Therefore, the radiating element 2 may be entirely located outside the range of the heat dissipation vent region Q, may be partially located within the range of the heat dissipation vent region Q, or may even be entirely located within the range of the heat dissipation vent region Q. Regardless of the configuration, the antenna characteristics and performance of the antenna structure M are not affected.

Since the antenna structure M of the present disclosure is combined with the heat dissipation vent structure of the electronic device D, the antenna structure M is located at a position close to the display component B1. However, the environment where the antenna structure M is located, i.e., the display component B1 of the electronic device D, adopts a sunken hinge structure design. When the user opens the upper cover (the display component B1 of the notebook computer) of the electronic device D, the portion where the display component B1 is connected to the keyboard component B2 is lower than the bottom surface of the keyboard component B2, thereby shielding the radiating surface of the antenna structure M and affecting antenna performance. Therefore, through the design in which the ratio of the first distance H1 to the second distance H2 is 2.1:1, that is, the ratio of the total height of the radiating element 2 of the antenna structure to the distance between one of the housing portions (the first housing portion or the second housing portion) is maintained at 2.1:1, and in combination with the grounding extension structure formed by the grounding metal element 3 electrically connecting the first housing portion S1 and the second housing portion S2, the antenna structure M can avoid being affected by shielding of the radiating surface, and can still maintain good antenna characteristics and performance to meet the broadband requirements of Wi-Fi® 6E/Wi-Fi® 7.

Although the present disclosure has been disclosed above with specific preferred embodiments, it is not intended to limit the present disclosure. A person skilled in the art can still make some modifications and refinements without departing from the spirit and scope of the present disclosure. Therefore, the protection scope of the present disclosure should be defined by the claims below.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. An electronic device, comprising:
a metal housing including a first housing portion and a second housing portion; and
an antenna structure disposed between the first housing portion and the second housing portion, the antenna structure comprising:
a heat dissipation bracket having a first surface and a second surface disposed opposite each other, and a third surface and a fourth surface disposed opposite each other, the third surface and the fourth surface being connected between the first surface and the second surface, and the heat dissipation bracket having a plurality of through holes, the plurality of through holes penetrating the first surface and the second surface;
a radiating element disposed on the first surface, the radiating element comprising a radiating portion, a grounding portion, and a feeding portion, the grounding portion and the feeding portion being connected to the radiating portion; and
a grounding metal element disposed on the second surface, the third surface, and the fourth surface, the grounding portion being connected to the grounding metal element, the portion of the grounding metal element located on the third surface being electrically connected to the first housing portion, and the portion of the grounding metal element located on the fourth surface being electrically connected to the second housing portion; wherein one of the first housing portion and the second housing portion is spaced apart from an upper edge of the radiating portion by a first distance, the other of the first housing portion and the second housing portion is spaced apart from the upper edge of the radiating portion by a second distance, and a ratio of the first distance to the second distance is 2.1:1.

2. The electronic device according to claim 1, wherein the radiating portion comprises a first arm and a second arm, the feeding portion is connected between the first arm and the second arm, the first arm and the second arm extend in opposite directions relative to the feeding portion, a length of the first arm is greater than a length of the second arm, and the grounding portion is connected to the first arm.

3. The electronic device according to claim 2, wherein the feeding portion is electrically connected to a feeding element, and the antenna structure feeds a signal through the feeding element such that the feeding portion and the first arm are excited to generate a first operating frequency band, and the feeding portion and the second arm are excited to generate a second operating frequency band and a third operating frequency band, and the second operating frequency band and the third operating frequency band are both higher than the first operating frequency band.

4. The electronic device according to claim 3, wherein a range of the first operating frequency band is from 2400 MHz to 2500 MHz, a range of the second operating frequency band is from 5150 MHz to 5850 MHz, and a range of the third operating frequency band is from 5925 MHz to 7125 MHz.

5. The electronic device according to claim 3, wherein the first distance is from 0.035 to 0.045 wavelength of the first operating frequency band.

6. The electronic device according to claim 1, wherein the plurality of through holes form a heat dissipation vent region on the first surface, and the radiating element is located outside the heat dissipation vent region.

7. The electronic device according to claim 1, wherein the plurality of through holes form a heat dissipation vent region on the first surface, and at least a portion of the radiating element is located within the heat dissipation vent region.

8. The electronic device according to claim 7, wherein the plurality of through holes are divided into two rows, the two rows of through holes are arranged side-by-side, each row of through holes is parallel to an extending direction of the radiating portion, and at least a part of the radiating portion is located between the two rows of through holes.

9. The electronic device according to claim 1, further comprising a display component having a screen, wherein, when the electronic device is in a form being operated by a user, the first surface faces the display component.

10. The electronic device according to claim 9, wherein a front edge of the first housing portion is flush with the first surface of the heat dissipation bracket, and a front edge of the second housing portion protrudes beyond the first surface of the heat dissipation bracket.

11. An antenna structure disposed in a metal housing, the metal housing including a first housing portion and a second housing portion, the antenna structure comprising:
a heat dissipation bracket having a first surface and a second surface disposed opposite each other, and a third surface and a fourth surface disposed opposite each other, the third surface and the fourth surface being connected between the first surface and the second surface, and the heat dissipation bracket having a plurality of through holes, the plurality of through holes penetrating the first surface and the second surface;
a radiating element disposed on the first surface, the radiating element comprising a radiating portion, a grounding portion, and a feeding portion, the grounding portion and the feeding portion being connected to the radiating portion; and
a grounding metal element disposed on the second surface, the third surface, and the fourth surface, the grounding portion being connected to the grounding metal element, the portion of the grounding metal element located on the third surface being electrically connected to the first housing portion, and the portion of the grounding metal element located on the fourth surface being electrically connected to the second housing portion; wherein one of the first housing portion and the second housing portion is spaced apart from an upper edge of the radiating portion by a first distance, the other of the first housing portion and the second housing portion is spaced apart from the upper edge of the radiating portion by a second distance, and a ratio of the first distance to the second distance is 2.1:1.

12. The antenna structure according to claim 11, wherein the radiating portion comprises a first arm and a second arm, the feeding portion is connected between the first arm and the second arm, the first arm and the second arm extend in opposite directions relative to the feeding portion, a length of the first arm is greater than a length of the second arm, and the grounding portion is connected to the first arm.

13. The antenna structure according to claim 12, wherein the feeding portion is electrically connected to a feeding element, and the antenna structure feeds a signal through the feeding element such that the feeding portion and the first arm are excited to generate a first operating frequency band, and the feeding portion and the second arm are excited to generate a second operating frequency band and a third operating frequency band, and the second operating frequency band and the third operating frequency band are both higher than the first operating frequency band.

14. The antenna structure according to claim 13, wherein a range of the first operating frequency band is from 2400 MHz to 2500 MHz, a range of the second operating frequency band is from 5150 MHz to 5850 MHz, and a range of the third operating frequency band is from 5925 MHz to 7125 MHz.

15. The antenna structure according to claim 13, wherein the first distance is from 0.035 to 0.045 wavelength of the first operating frequency band.

16. The antenna structure according to claim 11, wherein the plurality of through holes form a heat dissipation vent region on the first surface, and the radiating portion is located outside the heat dissipation vent region.

17. The antenna structure according to claim 11, wherein the plurality of through holes form a heat dissipation vent region on the first surface, and at least a portion of the radiating portion is located within the heat dissipation vent region.

18. The antenna structure according to claim 17, wherein the plurality of through holes are divided into two rows, the two rows of through holes are arranged side-by-side, each row of through holes is arranged along an extending direction of the radiating portion, and at least a portion of the radiating portion is located between the two rows of through holes.
